(19) United States
(12) Patent Application Publication
(10) Pub. No.: US 2024/0127034 A1
(43) Pub. Date: Apr. 18, 2024

(54) APPARATUS AND METHOD FOR DISTRIBUTED PROCESSING OF NEURAL NETWORK

(71) Applicant: ELECTRONICS AND TELECOMMUNICATIONS RESEARCH INSTITUTE, Daejeon (KR)

(72) Inventors: Sang-Cheol KIM, Daejeon (KR); Hyung-Kook JUN, Seoul (KR); Tae-Ho KIM, Daejeon (KR)

(73) Assignee: ELECTRONICS AND TELECOMMUNICATIONS RESEARCH INSTITUTE, Daejeon (KR)

(21) Appl. No.: 18/347,297

(22) Filed: Jul. 5, 2023

(30) Foreign Application Priority Data
Oct. 18, 2022 (KR) 10-2022-0134029

(51) Int. Cl. G06N 3/045; G06N 3/063

(52) U.S. Cl. CPC G06N 3/045; G06N 3/063

(57) ABSTRACT

Disclosed herein are an apparatus and method for distributed processing of a neural network. The apparatus may include a neural network model compiler for segmenting a neural network into a predetermined number of sub-neural networks, two or more neural processing units, and a neural network operating system for abstracting the sub-neural networks into a predetermined number of tasks, performing inference using the multiple neural processing units in a distributed manner in response to a neural network inference request from at least one application, and returning an inference result to the application.

### CROSS REFERENCE TO RELATED APPLICATION

This application claims the benefit of Korean Patent Application No. 10-2022-0134029, filed Oct. 18, 2022, which is hereby incorporated by reference in its entirety into this application.

### BACKGROUND OF THE INVENTION

### 1. Technical Field

The disclosed embodiment relates to technology for distributed processing of a large-scale neural network.

### 2. Description of the Related Art

With the recent increasing demand for Artificial Intelligence (AI) processing, special hardware for fast processing of an artificial neural network (referred to as a ‘neural network’ hereinbelow), the so-called ‘Neural Processing Unit (NPU)’, has emerged, and interest in hardware/software system configurations for such an NPU is also increasing.

A neural network is a system for inferring input using trained AI data. With the current explosive increase in AI-related services, various requirements related to inference arise. One of the requirements is to enable neural network segments to be executed on multiple NPUs in a distributed manner when it is difficult to execute a large-scale neural network on a single NPU due to the size thereof. When the neural network segments have parallelism, they may be executed on the multiple NPUs in a distributed manner, and this has an effect of improving performance.

Meanwhile, AI application services that currently exist are diverse, and when a large-scale application is developed, system software (a neural network model compiler or the like) is often run only in a specific NPU, among various types of NPUs. Therefore, large-scale neural network inference is not simple in such various and complicated hardware/software environments.

### SUMMARY OF THE INVENTION

An object of the disclosed embodiment is to provide an apparatus and method for segmenting a large-scale neural network to be executed by neural processing units in a distributed manner in a system including the multiple neural processing units.

An apparatus for distributed processing of a neural network according to an embodiment may include a neural network model compiler for segmenting a neural network into a predetermined number of sub-neural networks, two or more neural processing units, and a neural network operating system for abstracting the sub-neural networks into a predetermined number of tasks, performing inference by distributing the predetermined number of tasks abstracted to correspond to a neural network inference request of at least one application across the multiple neural processing units, and returning an inference result to the application.

Here, the neural network operating system may include a broker for distributing the predetermined number of tasks, abstracted to correspond to the neural network inference request of the at least one neural network application, across the multiple neural processing units and task processors for performing inference by processing the tasks input from the broker in the neural processing units.

Here, the neural network application and the broker of the neural network operating system may be executed on a CPU of a host, and each of the task processors of the neural network operating system may be executed on a CPU of each of the multiple neural processing units.

Here, the neural network application, the broker of the neural network operating system, and each of the task processors of the neural network operating system may be executed on a CPU of a single neural processing unit in the form of an embedded board, and the respective task processors may be executed on multiple accelerators of the CPU.

Here, control messages may be transmitted and received between the neural network application and the broker or between the broker and the task processor, and input/output data required for inference may be transmitted and received between the neural network application and the task processor.

Here, the broker may include a task abstraction unit for generating neural network tasks by abstracting the sub-neural networks acquired by segmenting the neural network, a task distributor for distributing each of the neural network tasks to one of the multiple task processors, a broker-side loader for loading a neural network file used for the neural network application in advance into the neural processing unit, and a broker-side connector for connecting the broker with the task processor.

Here, the task processor may include a resource abstraction unit for abstracting a resource for performing neural network inference into a task processor and logically connecting the resource with the task processor, a scheduler for setting an execution sequence of the tasks based on priority, a task-processor-side loader for receiving a neural network file used for the neural network application and installing a neural network in a corresponding neural processing unit, and a task-processor-side connector for registering the task processor in the broker.

Here, the task may include a neural-network-related task including a neural network task and a loader task, a system task including an idle task and an exception task, and a monitor task for monitoring the state of the task processor.

Here, the task processor may include a neural network object installed by loading a specific neural network, and the neural network object may be an interface that is connected when a neural network task is executed.

An apparatus for distributed processing of a neural network according to an embodiment includes memory in which at least one program is recorded and a processor for executing the program. The program may include a neural network operating system for returning a result of distributed inference, which is performed through multiple neural processing units in response to a neural network inference request from at least one application, to the application, and the neural network operating system may include a broker for abstracting sub-neural networks into a predetermined number of tasks and distributing the predetermined number of tasks, abstracted to correspond to the neural network inference request of the at least one application, across the multiple neural processing units and multiple task processors for performing inference by processing the tasks input from the broker in the neural processing units connected thereto.

Here, the neural network application and the broker of the neural network operating system may be executed on a CPU of a host, and each of the task processors of the neural network operating system may be executed on a CPU of each of the multiple neural processing units.

Here, the neural network application, the broker of the neural network operating system, and each of the task processors of the neural network operating system may be executed on a CPU of a single neural processing unit in the form of an embedded board, and the respective task processors may be executed on multiple accelerators of the CPU.

Here, the broker may include a task abstraction unit for generating neural network tasks by abstracting the sub-neural networks acquired by segmenting a neural network, a task distributor for distributing each of the neural network tasks to one of the multiple task processors, a broker-side loader for loading a neural network file used for the neural network application in advance into the neural processing unit, and a broker-side connector for connecting the broker with the task processor.

Here, the task processor may include a resource abstraction unit for abstracting a resource for performing neural network inference into a task processor and logically connecting the resource with the task processor, a scheduler for setting an execution sequence of the tasks based on priority, a task-processor-side loader for receiving a neural network file used for the neural network application and installing a neural network in a corresponding neural processing unit, and a task-processor-side connector for registering the task processor in the broker.

Here, the task may include a neural-network-related task including a neural network task and a loader task, a system task including an idle task and an exception task, and a monitor task for monitoring the state of the task processor.

A method for distributed processing of a neural network according to an embodiment may include generating a predetermined number of tasks by segmenting a large-scale neural network into a predetermined number of parts, loading neural network partitions into task processors respectively connected to multiple neural processing units, delivering input data of an application, for which inference is requested, to a neural network process when the neural network process for controlling an execution sequence and input/output of tasks generated by the application is executed, executing neural network tasks within the neural network process in the neural network processors, into which the neural network tasks are loaded, according to the execution sequence, and delivering output data of the neural network process to the application.

Here, the neural network partition may be in the form of a file, and may include a descriptor for describing the neural network and a kernel.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a block diagram of the configuration of an AI application execution system for inference in a single neural network in a general system having a single NPU;

FIG. 2 is a block diagram of the configuration of an AI application execution system for distributed processing of a large-scale neural network model in a system having multiple NPUs;

FIG. 3 is a block diagram of the configuration of a system for distributed processing of a neural network according to an embodiment;

FIG. 4 and FIG. 5 are exemplary views of the configuration of a hardware system for distributed processing of a neural network model;

FIG. 6 is an exemplary view of a process of abstracting a task of a neural network according to an embodiment;

FIG. 7 is a view illustrating a communication relationship between a neural network application, a broker, and a task processor according to an embodiment;

FIG. 8 and FIG. 9 are views illustrating hardware locations at which a neural network application and a neural network operating system are executed according to an embodiment;

FIG. 10 is a view illustrating a relationship between a neural network application, a hardware resource, and a neural network operating system according to an embodiment;

FIG. 11 is an exemplary view of distribution of the functions of a broker and a task processor in a neural network operating system according to an embodiment;

FIG. 12 is a flowchart for explaining a method for large-scale neural network inference based on multiple NPUs in a neural network operating system according to an embodiment;

FIG. 13 is an exemplary view illustrating a large-scale neural network inference process based on multiple NPUs in a neural network operating system according to an embodiment; and

FIG. 14 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

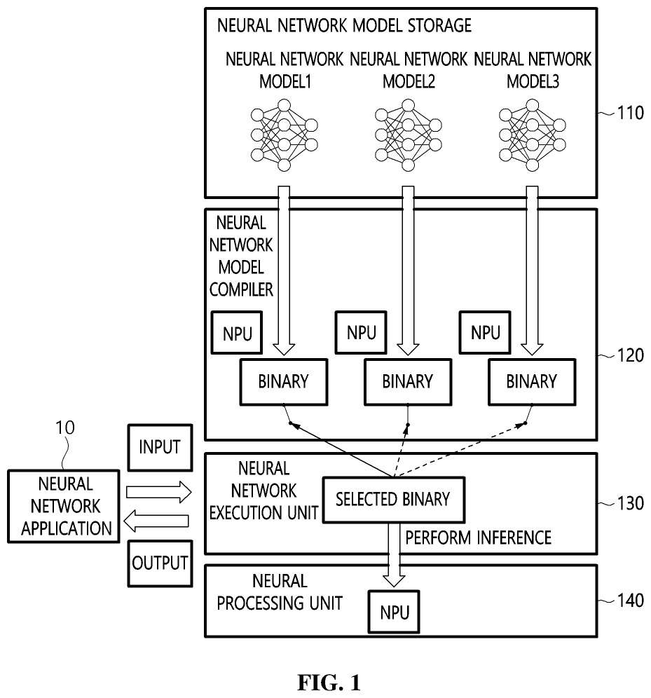

Hereinafter, an apparatus and method for distributed processing of a large-scale neural network using multiple neural processing units according to an embodiment will be described in detail with reference to FIGS. 1 to 14.

FIG. 1 is a block diagram of the configuration of an AI application execution system for inference in a single neural network in a general system having a single NPU.

Referring to FIG. 1, a general AI application execution system may include neural network model storage 110, a neural network model compiler 120, a neural network execution unit 130, and a neural processing unit 140.

The neural network model storage 110 stores at least one neural network model.

The neural network model compiler 120 generates a binary that enables a neural network model in the neural network model storage 110 to be executed on a specific NPU. Here, the neural network model compiler 120 may perform pruning, quantizing, and merging processes, which are processes for improving the speed of execution of a neural network while maintaining the precision.

The neural network execution unit 130 performs inference by selecting a binary for the neural network model requested by a neural network application 10 and returns the inference result to the neural network application 10.

The neural processing unit (NPU) 140 is hardware for accelerated processing of a neural network.

The neural network application 10, which is an application that requires neural network inference, requests a service from the neural network execution unit 130 using an inference API and acquires the result of the request.

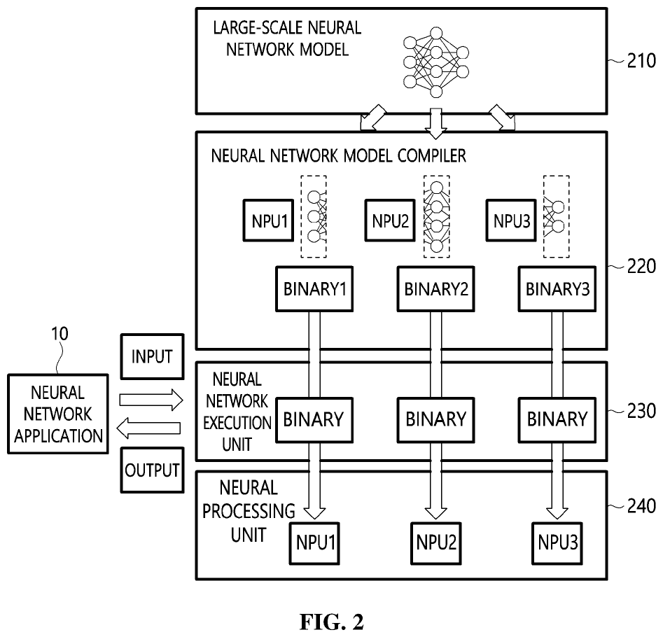

In the above-described conventional inference method illustrated in FIG. 1, a process for executing a single neural network on a single NPU is assumed. However, in order to execute various types of multiple neural networks (sub-neural networks that are generated when a large-scale neural network is segmented) in an environment in which multiple NPUs are present, the system configuration illustrated in FIG. 1 may be expanded as illustrated in FIG. 2.

FIG. 2 is a block diagram of the configuration of an AI application execution system for distributed processing of a large-scale neural network model in a multiple-NPU system.

Referring to FIG. 2, a large-scale neural network model 210 may be segmented into smaller sub-neural networks by a neural network model compiler 220.

A neural network execution unit 230 has to assign respective sub-neural network binaries generated by the neural network model compiler 220 to neural processing units 240 to suit the requirements of a neural network application 10.

Compared with FIG. 1, the system illustrated in FIG. 2 has difference in that the neural network model compiler 220 generates partition binaries for a partition graph that is generated by segmenting the large-scale neural network model 210 and in that multiple neural processing units (NPUs) are present.

The neural network execution unit 230 illustrated in FIG. 2 statically maps the respective partition binaries to the neural processing units 240 in a one-to-one manner. This may be very intuitive and simple, but has a limitation in that it is not possible to map the respective partition binaries to the neural processing units 240 in any of various manners. In order to overcome such a limitation, it is necessary to change the static mapping method illustrated in FIG. 2 to a dynamic mapping method.

Accordingly, the present disclosure proposes technology capable of dynamically mapping respective partition binaries to neural processing units such that multiple sub-neural networks acquired by segmenting a large-scale neural network are effectively executed on the multiple NPUs.

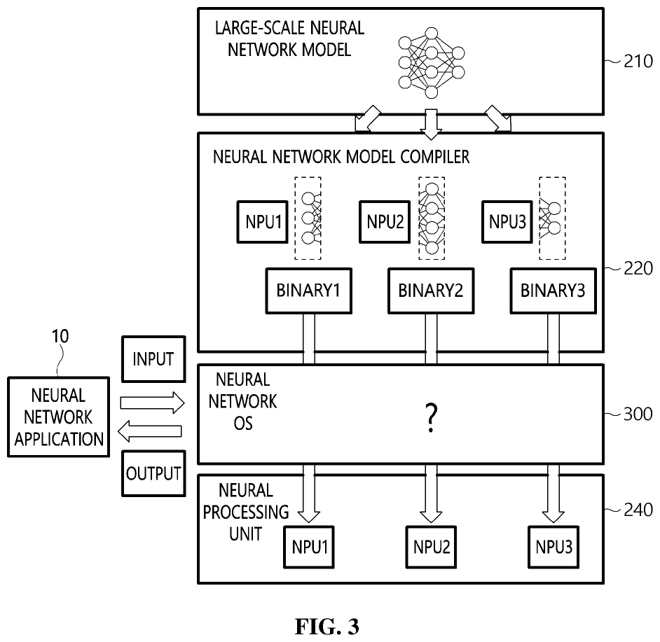

FIG. 3 is a block diagram of the configuration of a system for distributed processing of a neural network according to an embodiment.

Referring to FIG. 3, a neural network operating system (OS) 300 according to an embodiment dynamically maps the respective partition binaries of a large-scale neural network model 210, segmented by a neural network model compiler 220, to multiple NPUs.

Here, because the neural network OS 300 according to an embodiment uses a basic element called a ‘task’, it has an advantage in that, even though an NPU, which is a neural processing unit, is replaced with another one, a program can be easily executed without greatly modifying the program.

The neural network OS 300 is system software for abstracting tasks generated by a neural network application 10 to be in a form suitable to be mapped to NPUs in an environment in which one or more NPUs 240 are present and for mapping executable binaries generated by a neural network model compiler 220 to be distributed across the multiple NPUs, thereby maximizing performance.

Here, the neural network OS 300 may also perform various other functions of a conventional operating system, such as memory optimization, monitoring, and the like.

Meanwhile, the neural network application 10 may be an application configured to generate one or more various neural-network-related programs, to request inference from the neural network OS 300, and to receive the requested inference result.

The apparatus for distributed processing of a large-scale neural network based on multiple neural processing units according to an embodiment may be run in a hardware system having any of various configurations.

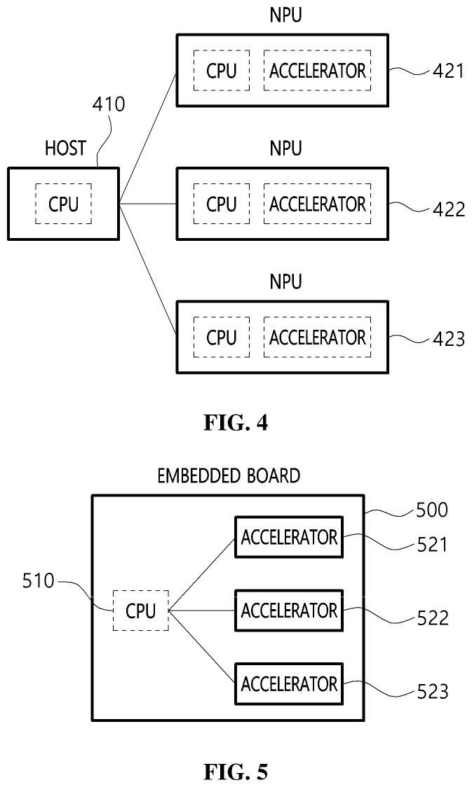

FIG. 4 and FIG. 5 are exemplary views of the configuration of a hardware system for distributed processing of a neural network model.

Referring to FIG. 4, an example of the hardware system for distributed processing of a neural network model may be configured with a single host 410 and multiple NPUs 421, 422, and 423.

The single host 410 includes a CPU, and each of the multiple NPUs 421, 422, and 423 may include a CPU and an accelerator.

Referring to FIG. 5, another example of the hardware system for distributed processing of a neural network model may be configured with a single NPU 500 in the form of an embedded board or one chip.

Here, the NPU 500 may include a single CPU 510 and multiple accelerators 521, 522, and 523 therein.

As illustrated in FIG. 5, one-to-many topology may also be applied even in a single-NPU board environment, as in FIG. 4.

Referring again to FIG. 3, the neural network application 10 and the neural network OS 300 may be software.

The neural network application 10 is an application executed based on the neural network OS 300, and may be executed in the form of a process or thread on a CPU as an application requesting neural network inference.

Here, the neural network application 10 may finally represent a neural network as a task by abstracting the same.

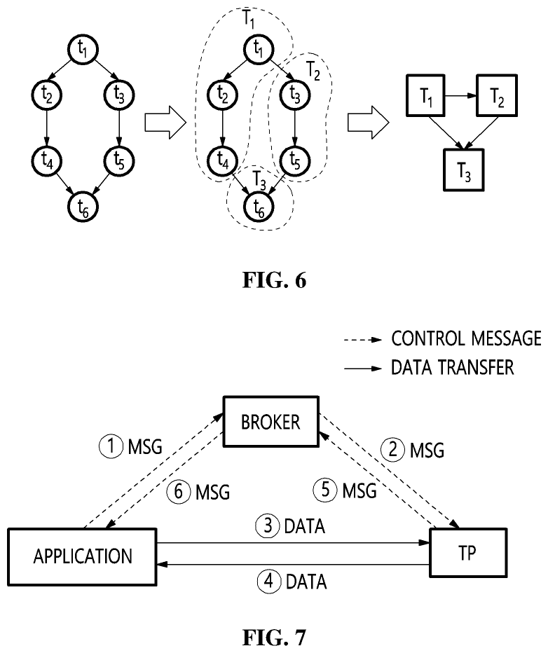

FIG. 6 is an exemplary view of a process of abstracting a task of a neural network according to an embodiment.

Referring to FIG. 6, a large-scale neural network may be segmented into multiple sub-neural networks. The sub-neural networks may be abstracted into tasks, e.g., T₁ to T₃.

Here, in the neural network application, the tasks finally acquired as described above have dependencies represented in the form of a Directed Acyclic Graph (DAG). As long as such dependencies are not violated, the tasks may be performed in parallel.

Meanwhile, the neural network OS 300 may be system software that collectively refers to all of a broker and a task processer.

Here, the broker functions as a mediator between an application and NPUs, and serves to distribute neural network inference requests from multiple applications across multiple NPUs to be processed.

The task processor (TP) is system software for operating and managing an NPU resource and processing tasks input from the outside, and may operate like a scheduler of a conventional Realtime Operating System (RTOS). The most important function of the task processor is to perform inference using an NPU accelerator for a neural network task.

FIG. 7 is a view illustrating a communication relationship between a neural network application, a broker, and a task processor according to an embodiment.

Referring to FIG. 7, control messages are used for communication between an application and a broker or between the broker and a task processor (TP).

Meanwhile, the application may directly transmit input data required for inference to the task processor (TP) and receive the inference result as output data.

Here, a neural network task in the application may exchange control messages and data, thereby performing inference, as illustrated in FIG. 7.

First, a control message is delivered from the application to the TP via the broker so as to execute a task (\textcircled{1}, \textcircled{2}), and when the neural network task is executed in the TP, input data and output data for inference are exchanged between the application and the TP (\textcircled{3}, \textcircled{4}). Here, when execution of the neural network task is terminated, the inference is terminated (\textcircled{5}, \textcircled{6}).

The neural network OS 300 internally abstracts a large-scale neural network application in the form of tasks and supports the tasks to be executed on multiple NPUs. Here, the types and number of neural network models in the application and the types and number of NPUs are not limited.

Hereinafter, locations at which the above-described neural network application 10 and neural network OS 300 are executed in the hardware system illustrated in FIG. 4 and FIG. 5 are described.

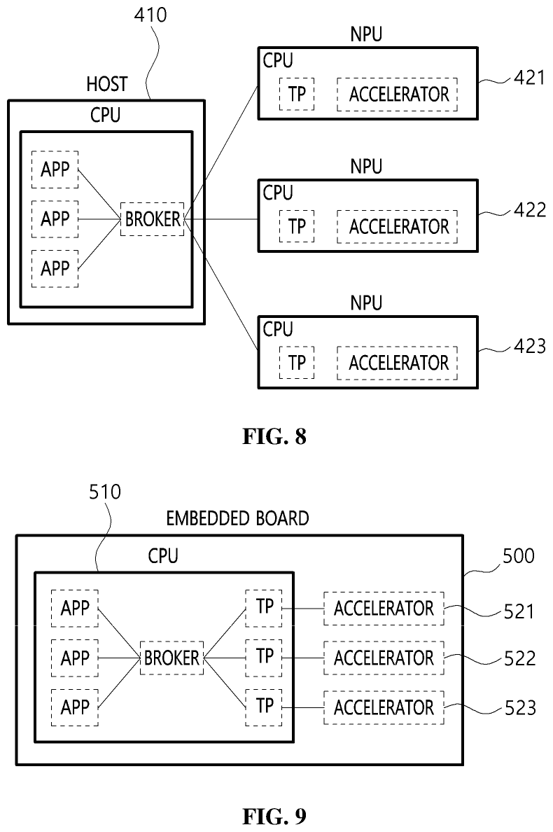

FIG. 8 and FIG. 9 are views illustrating the hardware locations at which a neural network application and a neural network operating system are executed according to an embodiment.

When a hardware system is configured to include a single host 410 and multiple NPUs 421, 422, and 423, as illustrated in FIG. 4, a neural network application and the broker of a neural network operating system (OS) may be executed on the CPU of the host 410, and the task processors of the neural network OS may be executed on the CPUs of the NPUs 421, 422, and 423, as illustrated in FIG. 8.

However, when the hardware system is configured with a single NPU 500 in the form of an embedded board without a host, as illustrated in FIG. 5, all of the neural network application, the broker of the neural network OS, and the task processors of the neural network OS may be executed on the CPU core 510 of the NPU 500, as illustrated in FIG. 9. Here, multiple task processors for managing multiple accelerators 521, 522, and 523 may be present.

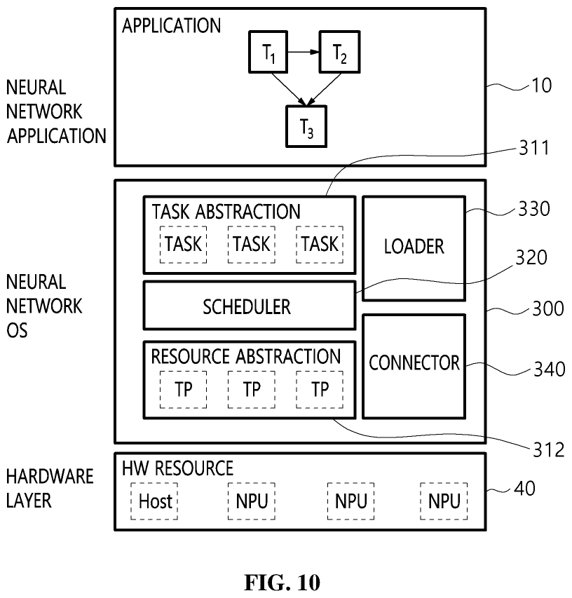

FIG. 10 is a view illustrating a relationship between a neural network application, a hardware resource, and a neural network operating system according to an embodiment.

Referring to FIG. 10, a neural network application 10 is an application for performing inference using at least one neural network, and may be abstracted in the form of tasks by being segmented by the neural network model compiler 220 illustrated in FIG. 3.

Hardware 40 may be configured to include a host and neural processing units (NPUs). However, because a CPU or a GPU is also capable of processing a neural network, not only NPUs but also CPUs and GPUs may be included in the neural processing units.

A neural network operating system (OS) 300 may include abstraction units 311 and 312, a scheduler 320, a loader 330, and a connector 340.

The abstraction units 311 and 312 may include a task abstraction unit 311 for abstracting a neural network into tasks and a resource abstraction unit 312 for abstracting hardware resources in the form of task processors.

The scheduler 320 may perform the function of most efficiently distributing the abstracted tasks across the task processors (TP) or setting an execution sequence based on the priority of the tasks.

The loader 330 may perform the function of loading or deleting neural network information and training data into or from the task processor in the NPU before the neural network task is executed in the task processor in the NPU.

Meanwhile, the neural network OS 300 may include a broker and a task processor (TP), as described above. Accordingly, the loader 330 of the neural network OS 300 may be categorized into a broker-side loader and a TP-side loader, and the connector 340 may be categorized into a broker-side connector and a TP-side connector.

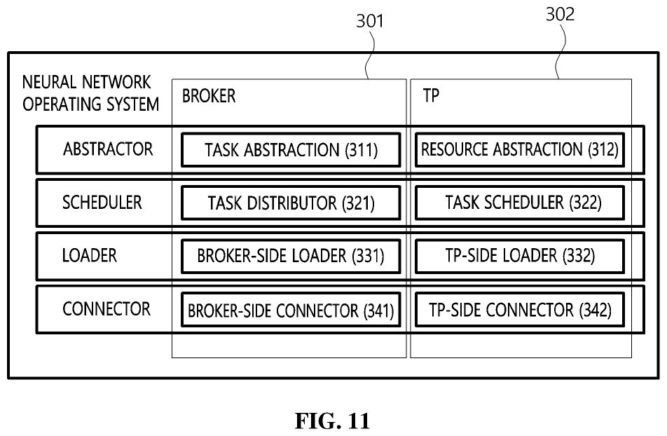

FIG. 11 is an exemplary view of distribution of the functions of a broker and a task processor in a neural network operating system according to an embodiment.

Referring to FIG. 11, a broker 301 may include a task abstraction unit 311, a task distributor 321, a broker-side loader 331, and a broker-side connector 341.

The task abstraction unit 311 abstracts all of neural networks in the form of tasks to perform inference. When neural networks are segmented into smaller sub-neural networks, the sub-neural networks may also be abstracted into tasks. Here, the neural network abstracted into a task is called a ‘neural network task’.

The task distributor 321 decides on a task processor (TP) 302 to which neural network tasks are to be submitted when two or more task processors (TPs) 302 are present. Generally, an algorithm for the task distributor 321 is written such that the neural network task is submitted to a task processor (TP) 302 that is expected to take the least time to execute the neural network task.

The broker-side loader 331 is used when an application preloads neural-network-related files (training data or the like) to an NPU. When the application 10 generates a loader task and submits the same to the broker 301, the broker-side loader 331 delivers the loader task to the task processor (TP) 302.

Because one or more task processors (TPs) 302 are connected to the broker 301, the broker 301 needs a function of waiting such that a specific task processor (TP) 302 is connected to the broker 301. To this end, when a connection is requested by a task processor (TP) 302 while waiting, the broker-side connector 341 immediately establishes a connection with the corresponding task processor (TP) 302.

The task processor 302 may include a resource abstraction unit 312, a task scheduler 322, a TP-side loader 332, and a TP-side connector 342.

The resource abstraction unit 312 abstracts a resource into a software module referred to as a task processor (TP), thereby logically connecting the resource to the task processor (TP) 302.

Here, the resources may include devices for processing a neural network, for example, an NPU, an accelerator, and the like.

Here, the task processor TP 302 has a unique ID corresponding to the resource and has a unique information descriptor for a neural processing unit.

The task scheduler 322 schedules tasks to be sequentially executed based on the priority of the tasks.

Here, the types of tasks include neural-network-related tasks, such as the above-described neural network task and loader task, and system tasks, such as an idle task and an exception task. Also, the types of tasks may further include a monitor task for monitoring the state of a TP, and the like.

Table 1 illustrates an example of types of tasks capable of being scheduled in a TP.

TABLE 1

| task category | task name | priority | description |
|---|---|---|---|
| system task | IdleTask | 0 | task that does nothing and is |
| | | | executed when another task |
| | | | having high priority is not |
| | | | executed |
| | ExceptionTask | 255 | task having highest priority |
| | | | and involved in emergency |
| | | | (system shutdown or the like) |
| loader task | LoadTask | 200 | task that is executed when |
| | | | specific neural network is |
| | | | installed |
| | UnloadTask | 200 | task that is executed when |
| | | | specific neural network is |
| | | | deleted |
| neural | NeuralTask | 100 | task that is executed when |
| network | | | inference is performed using |
| task | | | specific neural network |
| other tasks | MonitorTask | 250 | task for monitoring system |
| (monitoring, | | | state (e.g., number of |
| etc.) | | | waiting tasks, etc.) |

Referring again to FIG. 11, the TP-side loader 332 is run when a loader task is executed. The TP-side loader 332 receives neural-network-related files possessed by an application from the task processor (TP) and installs a neural network in a corresponding NPU. Accordingly, the TP may install multiple neural networks in an NPU and manage the same.

Here, when a neural network task is executed, it is necessary to check whether the neural network has been installed in the TP in advance. When the neural network is installed, it is executed in the form of a neural network object in the TP.

The TP-side connector 342 registers a TP 302 in the broker 301 once when the TP 302 is executed first. If a connection with the broker is disconnected, the TP-side connector 342 may repeat the process of registering the TP 302 in the broker 301 again.

Meanwhile, when a specific neural network is loaded into and installed in the TP 302, the TP 302 has the corresponding neural network object. The neural network object is an interface that is connected when a neural network task is executed, and has a total of five Application Program Interfaces (APIs). The respective APIs are functions that are automatically called when a neural network task or a loader task is executed.

Table 2 is neural network object APIs.

TABLE 2

| API | related task | description |
|---|---|---|
| Load( ) | LoadTask | install neural network in TP |
| Unload( ) | UnloadTask | delete neural network from TP |
| Predict( ) | Neural | perform neural network inference |
| SetInput( ) | Task | set input data for neural network inference |
| GetOutput( ) | | set output for storing result in memory |
| | | after neural network inference |

When it is configured as described above, a neural network application 10 executes a task on a neural network OS 300, thereby performing neural network inference.

In order to perform inference using a large-scale neural network that cannot be executed on a single NPU, neural network segments generated by a neural network model compiler 220 are required, and after the neural network segments are abstracted and executed, it is necessary to derive a comprehensive result.

Therefore, when a large-scale neural network is segmented, a process for overall control of subtasks acquired by segmenting an application is required, and such a process is called a neural network process (neural-net process).

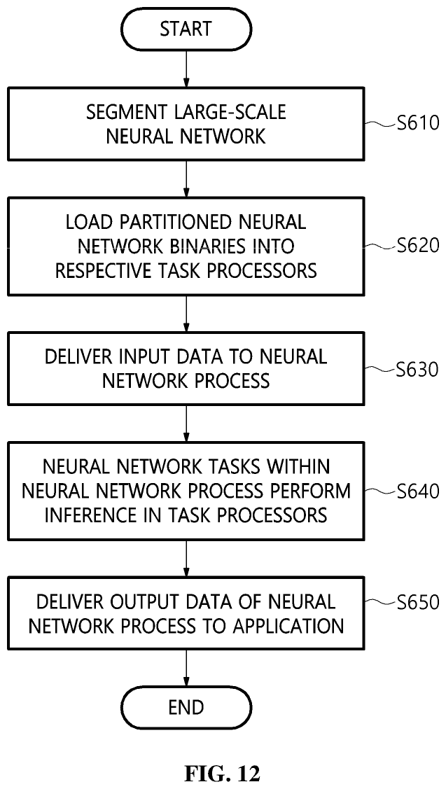

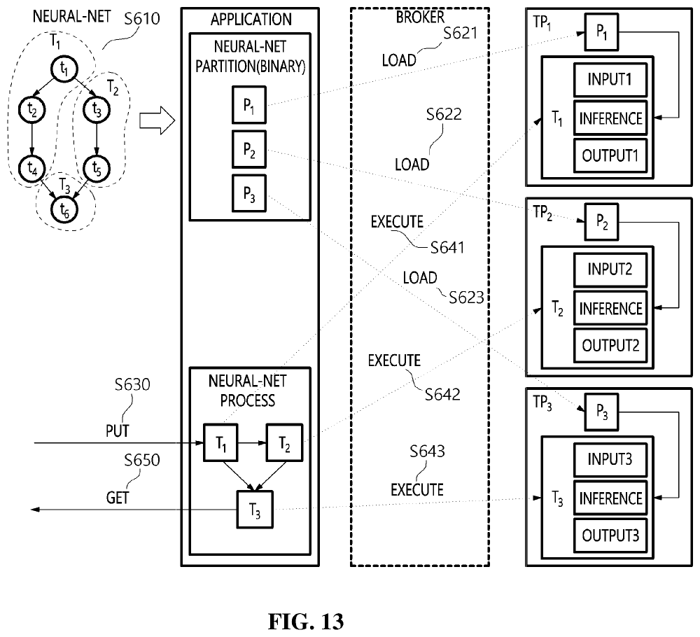

FIG. 12 is a flowchart for explaining a method for large-scale neural network inference based on multiple NPUs in a neural network operating system according to an embodiment, and FIG. 13 is an exemplary view illustrating a large-scale neural network inference process based on multiple NPUs in a neural network operating system according to an embodiment.

Referring to FIG. 12, a neural network model compiler segments a large-scale neural network into a predetermined number of parts, and a predetermined number of tasks are generated at step S610.

For example, a large-scale neural network is segmented into three parts, and three tasks, T₁, T₂, and T₃ may be generated, as illustrated in FIG. 13. Here, the tasks may be executed in the order of T₁, T₂, and T₃. Here, the output of T₁ may be input to T₂, and the input of T₃ may be the output of T₁ and T₂.

The application has to execute a neural-net process for controlling the execution sequence of T₁, T₂, and T₃ and the input/output thereof. In a simple example like the above-described example, there is no room for parallel execution of tasks, but if the tasks can be executed in parallel using threads or the like, the neural-net process has to be run to allow parallel execution.

Meanwhile, when the large-scale neural network is segmented into three parts, as illustrated in FIG. 13, three task processors, that is, TP₁, TP₂, and TP₃, may be prepared.

Referring again to FIG. 12, a broker-side loader 311 loads the parts of the neural network, acquired by the neural network model compiler 220, that is, partitions, into the respective TPs prepared in advance at step S620. That is, each neural network partition (a descriptor for describing a neural network and kernel (training data)) in the form of a file is loaded into and installed in each of the TPs for distributed execution.

For example, the neural network partition P₁ may be loaded into TP₁ at step S621, the neural network partition P₂ may be loaded into TP₂ at step S622, and the neural network partition P₃ may be loaded into TP₃ at step S623, as illustrated in FIG. 13.

Referring again to FIG. 12, when input data is delivered to the neural-net process at step S630, the input data of an application that requires inference is delivered to the neural-net process.

For example, the input data may be the input data of T₁, as illustrated in FIG. 13.

Referring again to FIG. 12, the neural network tasks within the neural net-process are respectively executed in the TPs into which they are loaded at step S640.

For example, the three neural network tasks of the neural-net process are sequentially executed in consideration of dependencies, as illustrated in FIG. 13. When dependencies are taken into account, T₁, T₂, and T₃ are executed in the order in which they are listed. Here, in order to execute a task, the task has to be executed in the TP to which the task is allocated via a broker. For example, T₁, T₂ and T₃ may be respectively allocated to TP₁, TP₂, and TP₃ to be distributed.

When T₁ is executed in TP₁, the input data is fetched from T₁, and this input data becomes Input1. For Input1, Output1 is generated through inference by involving the neural network partition P₁, and this data is delivered again to the neural-net process.

Here, Output1 of T₁ becomes Input2 of T₂, Output2 of T₂ becomes Input3 of T₃, and Output3 of T₃ is delivered again to the neural-net process. When the tasks are executed in the TPs as described above, data communication with the neural-net process may be performed for input and output.

Referring again to FIG. 12, the output data of the neural-net process is delivered to the application at step S650. Output3 delivered to the neural-net process may be delivered to the application as the final output.

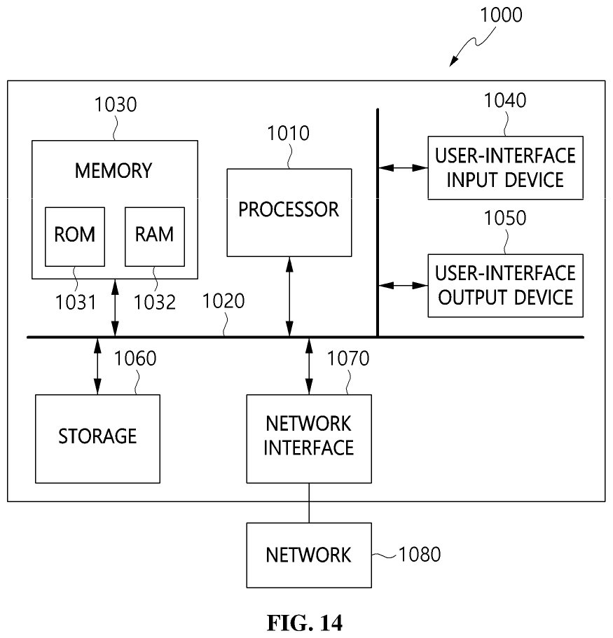

FIG. 14 is a view illustrating a computer system configuration according to an embodiment.

The apparatus for distributed processing of a neural network according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected to a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the disclosed embodiment, a large-scale neural network may be segmented and executed by neural processing units in a distributed manner in a system including the multiple neural processing units.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. An apparatus for distributed processing of a neural network, comprising:
a neural network model compiler for segmenting a neural network into a predetermined number of sub-neural networks;
two or more neural processing units; and
a neural network operating system for abstracting the sub-neural networks into a predetermined number of tasks, performing inference by distributing the predetermined number of tasks abstracted to correspond to a neural network inference request of at least one application across the multiple neural processing units, and returning an inference result to the application.

2. The apparatus of claim 1, wherein the neural network operating system includes
a broker for distributing the predetermined number of tasks, abstracted to correspond to the neural network inference request of the at least one neural network application, across the multiple neural processing units; and
task processors for performing inference by processing the tasks input from the broker in the neural processing units.

3. The apparatus of claim 2, wherein:
the neural network application and the broker of the neural network operating system are executed on a CPU of a host, and
each of the task processors of the neural network operating system is executed on a CPU of each of the multiple neural processing units.

4. The apparatus of claim 2, wherein:
the neural network application, the broker of the neural network operating system, and each of the task processors of the neural network operating system are executed on a CPU of a single neural processing unit in a form of an embedded board, and
the respective task processors are executed on multiple accelerators of the single neural processing unit.

5. The apparatus of claim 2, wherein:
control messages are transmitted and received between the neural network application and the broker or between the broker and the task processor, and
input/output data required for inference is transmitted and received between the neural network application and the task processor.

6. The apparatus of claim 2, wherein the broker includes
a task abstraction unit for generating neural network tasks by abstracting the sub-neural networks acquired by segmenting the neural network;
a task distributor for distributing each of the neural network tasks to one of the multiple task processors;
a broker-side loader for loading a neural network file used for the neural network application in advance into the neural processing unit; and
a broker-side connector for connecting the broker with the task processor.

7. The apparatus of claim 2, wherein the task processor includes
a resource abstraction unit for abstracting a resource for performing neural network inference into a task processor and logically connecting the resource with the task processor;
a scheduler for setting an execution sequence of tasks based on priority;
a task-processor-side loader for receiving a neural network file used for the neural network application and installing a neural network in a corresponding neural processing unit; and
a task-processor-side connector for registering the task processor in the broker.

8. The apparatus of claim 7, wherein the task includes
a neural-network-related task including a neural network task and a loader task,
a system task including an idle task and an exception task, and
a monitor task for monitoring a state of the task processor.

9. The apparatus of claim 2, wherein:
a task processor includes a neural network object installed by loading a specific neural network, and
the neural network object is an interface that is connected when a neural network task is executed.

10. An apparatus for distributed processing of a neural network, comprising:
memory in which at least one program is recorded; and
a processor for executing the program,
wherein
the program includes a neural network operating system for returning a result of distributed inference, performed through multiple neural processing units in response to a neural network inference request from at least one application, to the application, and
the neural network operating system includes
a broker for abstracting sub-neural networks into a predetermined number of tasks and distributing the predetermined number of tasks, abstracted to correspond to the neural network inference request of the at least one application, across the multiple neural processing units; and
multiple task processors for performing inference by processing the tasks input from the broker in the neural processing units connected thereto.

11. The apparatus of claim 10, wherein
the neural network application and the broker of the neural network operating system are executed on a CPU of a host, and
each of the task processors of the neural network operating system is executed on a CPU of each of the multiple neural processing units.

12. The apparatus of claim 10, wherein
the neural network application, the broker of the neural network operating system, and each of the task processors of the neural network operating system are executed on a CPU of a single neural processing unit in a form of an embedded board, and
the respective task processors are executed on multiple accelerators of the single neural processing unit.

13. The apparatus of claim 10, wherein the broker includes
a task abstraction unit for generating neural network tasks by abstracting the sub-neural networks acquired by segmenting a neural network;
a task distributor for distributing each of the neural network tasks to one of the multiple task processors;
a broker-side loader for loading a neural network file used for the neural network application in advance into the neural processing unit; and
a broker-side connector for connecting the broker with the task processor.

14. The apparatus of claim 10, wherein the task processor includes
a resource abstraction unit for abstracting a resource for performing neural network inference into a task processor and logically connecting the resource with the task processor;
a scheduler for setting an execution sequence of tasks based on priority;
a task-processor-side loader for receiving a neural network file used for the neural network application and installing a neural network in a corresponding neural processing unit; and
a task-processor-side connector for registering the task processor in the broker.

15. The apparatus of claim 10, wherein the task includes
a neural-network-related task including a neural network task and a loader task,
a system task including an idle task and an exception task, and
a monitor task for monitoring a state of the task processor.

16. A method for distributed processing of a neural network, comprising:
generating a predetermined number of tasks by segmenting a large-scale neural network into a predetermined number of parts;
loading neural network partitions into task processors respectively connected to multiple neural processing units;
delivering input data of an application, for which inference is requested, to a neural network process when the neural network process for controlling an execution sequence and input/output of tasks generated by the application is executed;
executing neural network tasks within the neural network process in the neural network processors, into which the respective neural network tasks are loaded, according to the execution sequence; and
delivering output data of the neural network process to the application.

17. The apparatus of claim 16, wherein the neural network partition is in a form of file, and includes a descriptor for describing the neural network and a kernel.
